(19) United States
(12) Patent Application Publication
(10) Pub. No.: US 2009/0307038 A1
(43) Pub. Date: Dec. 10, 2009

(54) SYSTEM AND METHOD FOR CREATION OF DATA FEEDS BASED ON CALENDER MEETING PARTICIPANTS

(75) Inventors: Al Chakra, Apex, NC (US); Melvin R. Jones, JR., Chapel Hill, NC (US); Julie A. Meserve, Raleigh, NC (US)

Correspondence Address: IBM RALEIGH IPLAW (DG);C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 12/136,623

(22) Filed: Jun. 10, 2008

(51) Int. Cl. G06Q 10/00; G06Q 99/00

(52) U.S. Cl. 705/8; 705/1

(57) ABSTRACT

In some embodiments, a method for determining data feeds in an electronic calendar comprises identifying participants of a meeting scheduled in the electronic calendar and determining topics relevant to the participants of the meeting. The method can also comprise selecting data feeds based on the topics relevant to the participants of the meeting, wherein the data feeds provide information about the topics. The method can also include presenting the data feeds to one or more of the participants of the meeting.

### TECHNICAL FIELD

Embodiments of the inventive subject matter generally relate to the field of calendar software, and more particularly, to methods for automatically creating data feeds based on calendar meeting participants.

### BACKGROUND

Users often use calendar software to schedule meetings. However, the software generally relies on users to efficiently enter meeting data and information about the meeting's participants. Typically, a user contacts other meeting participants, determines their availability, schedules the meeting, and enters information about the attendees. Some calendar software provides functionality limited to verifying whether the meeting participants are available at the proposed meeting time. Because using calendaring software typically requires human intervention, calendaring software often does not report important relationships and relevant data.

### SUMMARY

In some embodiments, a method for determining data feeds in an electronic calendar comprises identifying participants of a meeting scheduled in the electronic calendar and determining topics relevant to the participants of the meeting. The method can also comprise selecting data feeds based on the topics relevant to the participants of the meeting, wherein the data feeds provide information about the topics. The method can also include presenting the data feeds to one or more of the participants of the meeting. In some embodiments, the method can further comprise determining the participants' meeting schedules and displaying one or more alternate schedules because one or more of the participants has a scheduling conflict.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating a calendar system configured to determine and present data feeds based on meeting participants, according to some embodiments of the invention.

FIG. 2 is a block diagram illustrating the operations for determining meeting schedules and presenting data feeds related to the meeting's participants, according to some embodiments of the invention.

FIG. 3 is a conceptual diagram illustrating screenshots associated with determining and presenting relevant data feed information.

FIG. 4 is a flow diagram illustrating operations for selecting, updating, and presenting data feeds, according to some embodiments of the invention.

FIG. 5 is a block diagram illustrating a computer system configured to determine and present relevant data feeds related to a meeting participant's profile, according to some embodiments of the invention.

### DESCRIPTION OF EMBODIMENT(S)

The description that follows includes example systems, methods, techniques, instruction sequences, and computer program products that embody techniques of the present inventive subject matter. However, it is understood that the described embodiments may be practiced without these specific details. In some instances, well-known instruction instances, protocols, structures, and techniques have not been shown in detail in order not to obfuscate the description.

### INTRODUCTION

Users typically use calendaring software that requires users to enter information about meeting times. Typically, a user schedules a meeting by contacting other meeting participants, determining their availability, and scheduling the meeting. Sometimes the user may even enter information (e.g., text, hyperlinks, etc.) about the meeting participants. This information is generally based on the user's personal knowledge of the meeting participants. Although some calendar software applications may interface with other calendaring software to verify that all the meeting participants are available at the proposed meeting time, most of the work of scheduling the meeting and entering participant information still requires human intervention. For example, the user scheduling the meeting may look through the list of attendees and add extra data and/or links based on personal knowledge of the attendee. Users may use this data to indicate a participant's field of interest, remind them about relevant information, give them additional background about the meeting attendees, etc. However, because human interaction is involved, some important relationships and relevant data may be overlooked. As a result, users may want a system that automates the process of searching for information and creating relevant data feeds about the meeting's participants. Some embodiments of the inventive subject matter describe methods to automatically insert, into calendar entries, data feeds about the meeting's participants. The following discussion describes this and other important features in greater detail.

### Example Architecture and Operating Environments

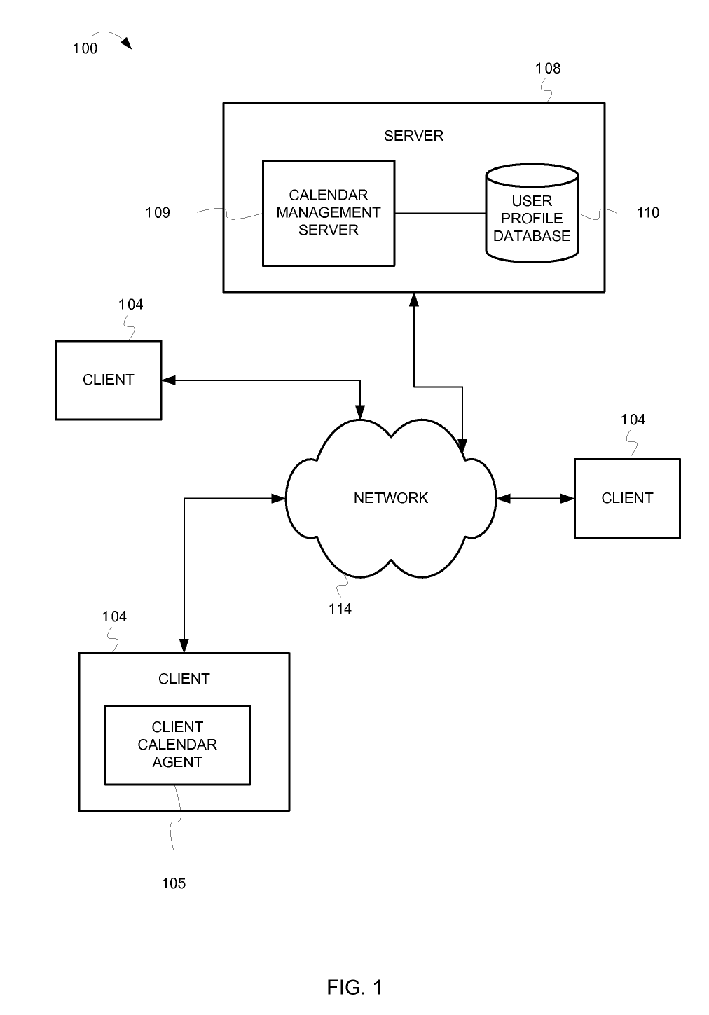

FIG. 1 is a block diagram illustrating a calendar system configured to determine and present data feeds based on meeting participants, according to some embodiments of the invention. As shown in FIG. 1, the system 100 includes a server 108 and clients 104. The server 108 includes a calendar management server 109 and a user profile database 110. The calendar management server 109 includes logic (e.g., software) for determining data feeds and transmitting them to the client's calendaring agent 105. The user profile database 110 includes information about the users, their business contacts, and other meeting participants. The information stored in the database 110 can include the participants' location, interests, participant related keywords to seed a general internet search (e.g., Chicago Cubs), and other relevant pieces of information (e.g., location, children's names, favorite food, etc). In some instances, the calendar management server 109 prompts users to step through an electronic questionnaire and answer questions about the meeting participants' interests and preferences. In other instances, the calendar management server 109 can allow users to manually enter information about the meeting participants (e.g., married with three children, oldest son in college, etc). The calendar management server 109 can interface with the user profile database 110 to access this information and present these notes as part of meeting reminders, meeting notes, or other meeting information. The calendar management server 109 can also perform a general search and identify the latest articles related to the meeting participants' field of interest. For example, the user profile database 110 may indicate that a meeting participant is a baseball fan. The calendar management server 109 can perform a search (e.g., on the internet) for recent baseball articles (e.g., determine if there are ongoing baseball events, news about the players, etc) and display links to these articles on the user's client calendar agent 105. Thus, when users meet the other attendees, these notes will help them strike up conversations, appear knowledgeable about the attendees' field of interest, ask relevant questions, and maintain a good business relationship.

In some instances, the calendar management server 109 can analyze relationships between meetings and their participants. The calendar management server 109 can determine whether all the participants are available at the proposed meeting time. If the meeting participants are busy at the proposed meeting time, the calendar management server 109 can go through the participants' calendar entries to determine available times and suggest multiple alternate meeting dates and times when all the meeting participants are available. In some instances, users may configure the calendar management server 109 to schedule a “buffer time” in between meetings to account for meetings running late, etc. Thus, automating the process of rescheduling meetings ensures that no participant is overlooked. The calendar management server 109 can interface with the client's calendar agent 105 to display alternate meeting dates and times along with relevant data feeds about the meeting's participants. As noted above the data feeds can include latest articles related to the meeting participants' field of interest, the participants' location, and other relevant pieces of information additional (e.g., location, children's names, favorite food, etc).

The server 108 and the clients 104 are connected to a network 114. The communication network 114 can include any technology suitable for passing communication between the clients and servers (e.g., Ethernet, 802.11n, SONET, etc.). Moreover, the network 114 can be part of other networks, such as cellular telephone networks, public-switched telephone networks (PSTN), cable television networks, etc. Additionally, the server 108 and clients 104 can be any suitable computing devices capable of executing software in accordance with the embodiments described herein.

### Example Calendar Management Server Operations

This section describes operations associated with some embodiments of the invention. The flow diagrams will be described with reference to the architectural block diagram presented above. However, in some embodiments, the operations can be performed by logic not described in the block diagrams; furthermore, some embodiments can perform more or less than the operations shown in any flow diagram. In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel.

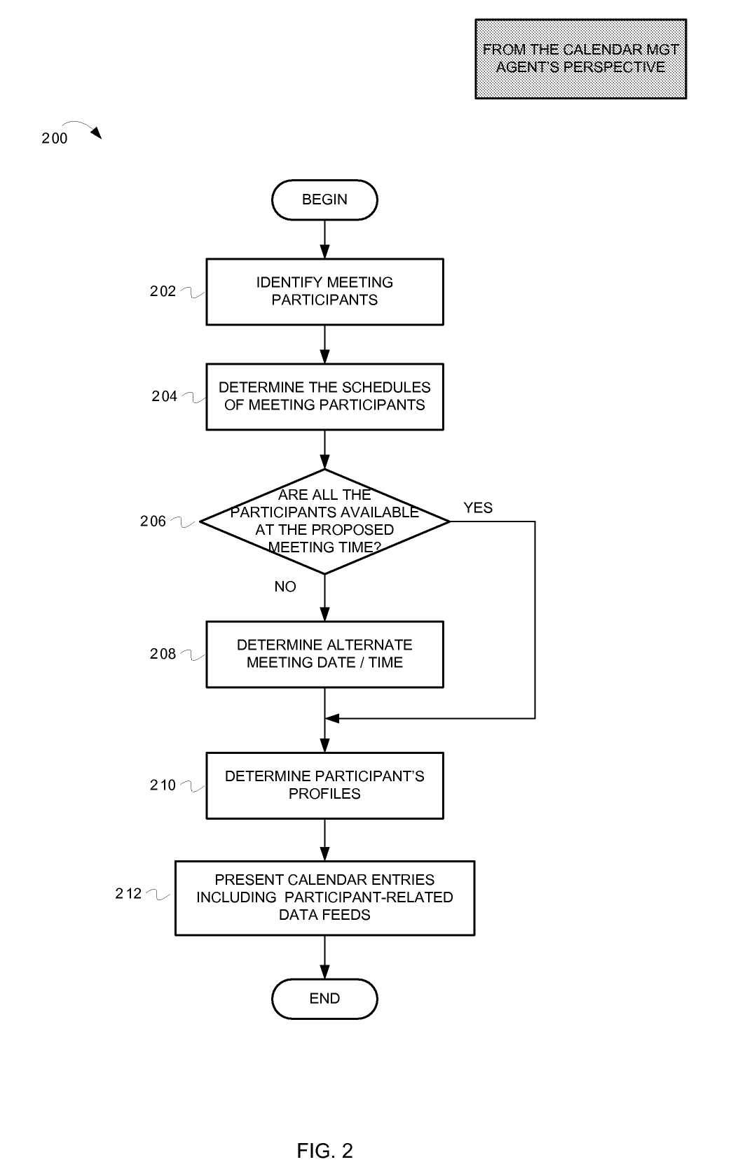

FIG. 2 is a block diagram illustrating the operations for determining meeting schedules and presenting data feeds related to the meeting's participants, according to some embodiments of the invention. The following discussion will describe the flow 200 with reference to the system of FIG. 1. The flow diagram 200 begins at block 202.

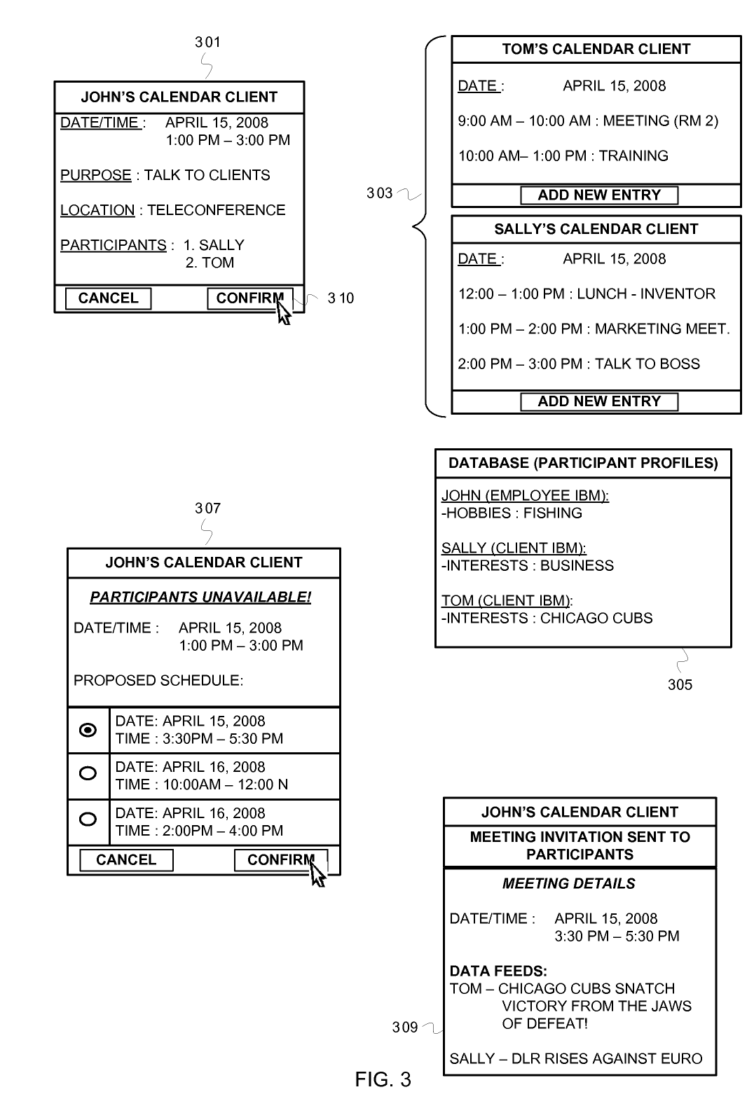

At block 202, the calendar management server 109 identifies participants to a meeting scheduled using an electronic calendar. When a meeting initiator confirms a meeting, the client calendar agent 105 sends the meeting information (e.g., in an XML file) including the meeting date, time, participants, etc. to the calendar management server 109. In turn, the calendar management server 109 determines whether the participants are available and determines relevant data feeds. FIG. 3 is a conceptual diagram illustrating screenshots associated with determining and presenting relevant data feed information. Screenshot 301 shows an example interface presenting meeting details including date, time, location, and meeting participants. In FIG. 3, the user (i.e., John) confirms the meeting by pressing the confirm button 310. Referring back to FIG. 2, after the calendar management server 109 receives the meeting details, the flow continues at block 204.

At block 204, the calendar management server 109 determines the meeting participants' schedules. In some instances, the calendar management server 109 can interface with other calendaring systems used by meeting participants to determine their schedules. The calendar management server 109 can determine when the meeting participants are available and in some instances can also temporarily store this information (e.g., in a local cache). In FIG. 3, the calendar management server 109 may interface with the participants' (i.e., Tom and Sally) calendars 303 to determine their meeting schedules (e.g., Tom has a meeting from 9:00 am to 10:00 am, Sally has no meetings after 3:00 pm, etc). Referring back to FIG. 2, after the calendar management server determines the participants' meeting schedules, the flow continues at block 206.

At block 206, the calendar management server 109 determines whether all the participants are available at the proposed meeting time. The calendar management server 109 can perform a perfunctory search to determine if all participants are available at the proposed meeting time. Also, the calendar management server 109 can perform a more exhaustive search to determine the participants' availability over a longer time range (e.g., two weeks, a month, etc). For example, in FIG. 3, the calendar management server 109 can determine that although Tom is available from 1:00 pm to 3:00 pm to attend the meeting, Sally is busy during that time (refer screenshots 303). The calendar management server 109 may also determine that both Tom and Sally are available after 3:00 pm and are available the next day. Referring back to FIG. 2, if the calendar management server 109 determines that all the meeting participants are available, the flow continues at block 210. Otherwise, the flow continues at block 208, where the calendar management server 109 reschedules the meeting to accommodate all the attendees.

At block 208, the calendar management server 109 identifies alternate meeting dates and times depending on the availability of the other participants. In some instances, the calendar management server 109 can use any suitable algorithm to parse through its schedule information and determine dates and times when all the meeting participants are available. The calendar management server 109 can display the alternate meeting times to a user via a client calendar agent 105. The user can select one of the proposed schedules by clicking on a radio button, selecting from a drop down menu, or by other means. In some instances, the user may choose to manually reschedule the meeting by entering an alternate meeting date and time. In other instances, users may have the option of prompting the calendar management server 109 to identify and present all the available meeting dates and times over a certain window of days (e.g., couple of months). In FIG. 3, screenshot 307 depicts the calendar management server rescheduling and suggesting alternate meeting schedules. The calendar management server 109 displays, via client's calendar agent 105, that the participants are unavailable and suggests an alternate schedule. The user (John) can select from one of the proposed schedules and confirm the meeting. Once John confirms the meeting, the client calendar agent 105 sends a meeting invite to the other participants. Referring back to FIG. 2, the flow continues at block 210.

At block 210, the calendar management server 109 determines the participants' profile information, which can include participants' location, interests, and other relevant information. In some instances, information about meeting participants can be stored in a user profile database 110 located on the server 108. In some instances, the user steps through an electronic questionnaire inquiring about their meeting participant's interests and preferences. In other instances, users may manually type in information about the meeting participants (e.g., children's names, favorite restaurant, etc). Later (e.g., when presenting meeting reminders, calendar entries, etc.), the calendar management server 109 can present the user's notes about the participant. Additionally, the calendar management server 109 can search the Internet and present recent articles (or links) related to the participants' fields of interest. In some embodiments, the calendar management server 109 may even interface with social networking websites to determine other information about the meeting attendees. The calendar management server 109 can include logic for determining the relevance and age of the information, sift out the old data, and present only the latest information. FIG. 3's block 305 shows an example database including the participant's profiles. For example, Tom is a fan of the Chicago Cubs and Sally is interested in business related news. The calendar management server 109 may search online news websites and find articles about the Cubs and business news. In some embodiments, the calendar management server 109 can determine and record a final score for a Cubs game and recent performance of certain stock indices. In FIG. 2, after the calendar management server 109 determines relevant information about the meeting's participants, the flow continues at bock 212.

At block 212, the calendar management server 109 interfaces with the client calendar agent 105 to present calendar entries including the data feeds related to each of the meeting participants. The client calendar agent 105 can present relevant data feeds as part of the calendar entries, meeting reminders/notices, or other calendar notifications. By accessing calendar entries, meeting notices/reminders, etc., users have instant access to the data feeds relevant to the meeting participants. Using the client calendar agent 105, users can also connect to the calendar management server 109 to update the data feeds. For example, users can configure the calendar management server 109 to search for updates periodically, on the day of the meeting, upon request, etc. In FIG. 3, the screenshot 309 shows an interface presented on a user's client calendar agent 105. The calendar management server 109 can send the modified meeting schedule in an invitation to the other participants and can display the relevant data feeds after the meeting is confirmed. As a result, before the meeting, the user (John) now knows that the Chicago Cubs played and won an exciting game and that the dollar is doing well in the international markets. This information may help John forge a stronger relation with his business partners. Referring back to FIG. 2, after the calendar management server displays the relevant data feeds, the flow ends.

The discussion will continue with a more detailed description about how some embodiments of the calendar management server can select and process data feeds for calendar entries.

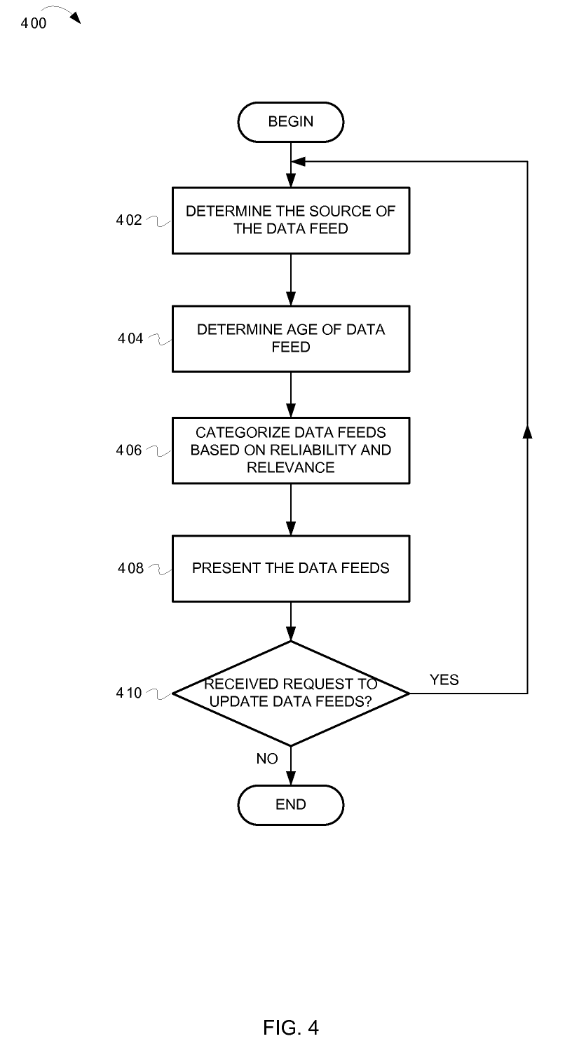

FIG. 4 is a flow diagram illustrating operations for selecting, updating, and presenting data feeds, according to some embodiments of the invention. The calendar management server 109 can create the data feeds at various times, such as in response to a user's request, after sending a meeting invitation, after the participants confirm the meeting, at regular intervals (e.g., every two days, every week), etc. The following discussion will describe the flow 400 with reference to the system of FIG. 1. The flow diagram 400 begins at block 402.

At block 402, the calendar management server 109 determines a source for a data feed. The data feed's source can include an attendee's information in an organization's database, calendar profile, or user entered data (e.g., results of a questionnaire). In some instances, the information source can also include social networking websites, the attendees' personal website, and other sources on the internet. The calendar management server 109 can present the information in a user profile database 110 directly as a data feed or can use the information to generate other data feeds. For example, the calendar management server 109 may interface with the user profile database 110, determine that the meeting participant is a baseball fan, and present this information in a data feed on the client calendar agent 105. Additionally, the calendar management server can also use this information (i.e., baseball) as a keyword to seed an internet search and present links to recent baseball articles. In some instances, users may have the option of choosing the source of the data feed. Users may also have the option of selecting specific websites from which to search for information. In other instances, the calendar management server 109 may display information gleaned from all the sources. After the calendar management server 109 identifies the data feeds' source, the flow continues at block 404.

At block 404, the calendar management server 109 determines the age of the data feed. In some instances, users may specify the maximum allowable age of the data feeds. For example, some users may want to view relevant information that has been updated in the last month, while other users may want to view information only if it has been updated in the past two days. The calendar management server 109 can ignore older data or display it as a last resort if no other information is available. After the calendar management server 109 determines the age of the relevant data feeds, the flow continues at block 406.

At block 406, the calendar management server 109 categorizes the data feeds based on their age, relevance, and reliability of the source. For example, information obtained from the participants' organization database or from the user's notes may be considered accurate. Similarly, information about the attendee obtained from a general internet search or from social networking websites may not be as accurate. Likewise, data feeds can be classified by their age. For example, the calendar management server 109 may give recent news articles about the attendee's interests more preference as compared to older articles. After the calendar management server 109 categorizes the data feeds, the flow continues at block 408 where the data feeds are presented.

At block 408, the calendar management server 109 interfaces with the client calendar agent 105 to present the data feeds. The calendar management server 109 can arrange data feeds differently based on their relevance, reliability, and age. For example, the data feeds can be presented in order of age, starting with the most recent data feed. In some instances, the calendar management server 109 can also color code the data feeds depending on their reliability and age. For example, information on an attendee's website may be displayed in green indicating it is the most reliable data. Similarly, information obtained from an arbitrary source on the internet may be displayed in red indicating it is the least reliable data. In some instances, users can also include relevant links to documents, articles, etc. in the data feeds. For example, if an inventor is meeting with his patent attorney, the inventor might include links to relevant disclosure documents to prepare for the meeting. The flow then continues at block 410.

At block 410, the calendar management server 109 determines whether it received a request to update the data feeds. As noted above, the calendar management server 109 can create data feeds in response to a user's request, when a meeting invite is sent out, when a meeting is confirmed by participants, at a regular interval (e.g., every two days, every week, etc), on the day of the meeting, etc. The calendar management server 109 can update data feeds periodically so that users have the latest information about the meeting attendees and their fields of interest. If the calendar management server 109 receives a user request to update the data feeds, the flow continues at block 402. Otherwise, the flow ends without modifying the data feeds.

### Example Server Architecture

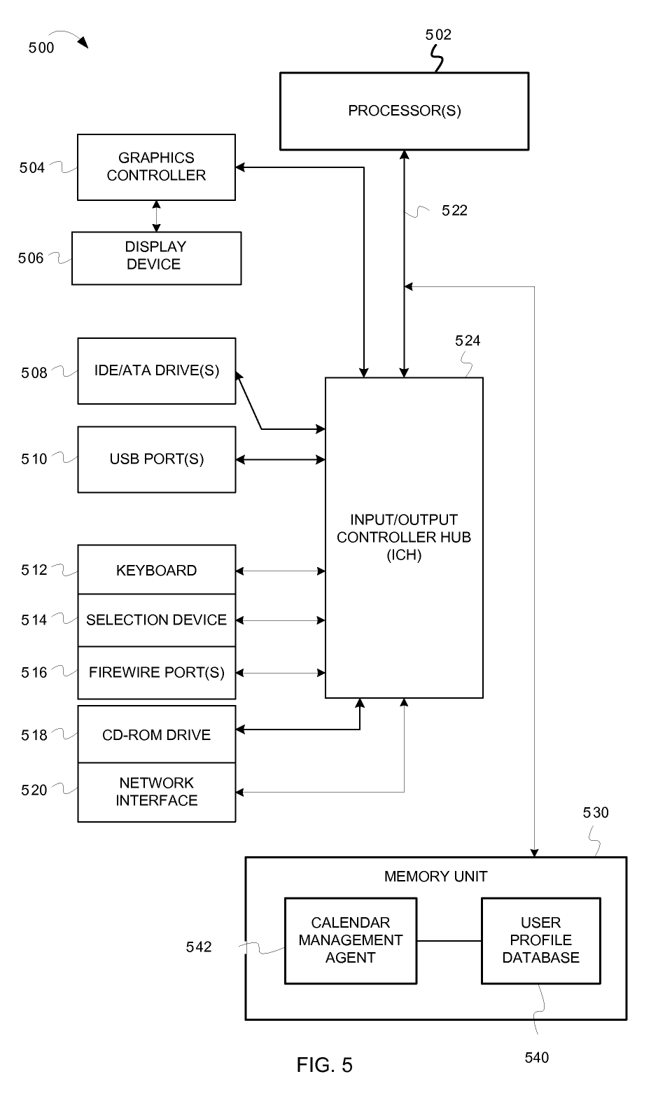

FIG. 5 is a block diagram illustrating a computer system configured to determine and present relevant data feeds related to a meeting participant's profile, according to some embodiments of the invention. The computer system 500 can be configured to operate similar to the server shown in FIG. 1.

The computer system 500 includes a processor 502. The processor 502 is connected to an input/output controller hub 524 (ICH) also known as a south bridge. A memory unit 530 interfaces with the processor 502 and the ICH 524. The main memory unit 530 can include any suitable random access memory (RAM), such as static RAM, dynamic RAM, synchronous dynamic RAM, extended data output RAM, etc.

In one embodiment, the memory unit 530 includes a calendar management server 542 and a user profile database 540. The calendar management server 542 includes logic (e.g., software) to determine the appropriate data feeds and display them on a client calendar agent. The user profile database 540 can include information about the user, their clients, and other meeting participants. This information can include participants' interests, location, relevant keywords to seed an internet search, and other relevant pieces of information. The calendar management server 542 can interface with the user profile database 540 to determine and present the information in the database whenever users schedule meetings with other people. The calendar management server can also perform a general internet search (e.g., social networking websites, attendees' personal website, news websites, etc) to identify and present the latest articles related to the meeting participants and their fields of interest.

In some embodiments, the calendar management server 542 can also determine whether all the participants are available at the proposed meeting time. If not, the calendar management server 542 may go through the participants' calendar entries to determine available times and suggest multiple alternate meeting dates and times when all the meeting participants are available. The calendar management server 542 can interface with the client's calendar agent (not shown) to display alternate meeting dates and times along with relevant data feeds about the meeting's participants.

The ICH 524 connects and controls peripheral devices. In FIG. 5, the ICH 524 is connected to IDE/ATA drives 508 (used to connect external storage devices) and to universal serial bus (USB) ports 540. The ICH 524 may also be connected to a keyboard 512, a selection device 514, firewire ports 516 (for use with video equipment), CD-ROM drive 518, and a network interface 520. The ICH 524 can also be connected to a graphics controller 504. The graphics controller is connected to a display device (e.g., monitor).

In some embodiments, the computer system 500 can include additional devices and/or more than one of each component shown in FIG. 5 (e.g., video cards, audio cards, peripheral devices, etc.). For example, in some instances, the computer system 500 may include multiple processors, multiple cores, multiple external CPU's. In other instances, components may even be integrated or subdivided. In addition, embodiments may be embodied in an electrical, optical, acoustical or other form of propagated signal (e.g., carrier waves, infrared signals, digital signals, etc.), or wireline, wireless, or other communications medium.

Any of the embodiments may include a computer program product, or software, that includes a machine-readable medium having stored thereon instructions, which may be used to program a computer system (or other electronic devices) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

### CONCLUSION

While the embodiments are described with reference to various implementations and exploitations, it will be understood that these embodiments are illustrative and that the scope of the inventive subject matter is not limited to them. In general, techniques for using an intelligent calendar system for the automatic creation of data feeds based on calendar meeting participants are described herein and may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for determining data feeds in an electronic calendar, the method comprising:
identifying participants of a meeting scheduled in the electronic calendar;
determining topics relevant to the participants of the meeting;
selecting data feeds based on the topics relevant to the participants of the meeting, wherein the data feeds provide information about the topics; and
presenting the data feeds to one or more of the participants of the meeting.

2. The method of claim 1 further comprising:
determining the participants' meeting schedules, and
displaying one or more alternate schedules because one or more of the participants has a scheduling conflict.

3. The method of claim 1, wherein the determining topics includes searching for key words in profiles associated with the participants, wherein the profiles are stored in a profile database associated with the electronic calendar.

4. The method of claim 1, wherein the information about the topics includes one or more of personal notes about one or more of the participants, links to online articles, information from social networking websites, electronic business cards, data from a participant's employer database, and information from web pages about one or more of the participants.

5. The method of claim 1, wherein information for data feeds can be arranged and presented based on one or more of the data feeds' sources and the data feeds' ages.

6. The method of claim 1, wherein presenting the data feeds can include any one or more of ordering data feeds based on their reliability, color coding data feeds depending on the data feeds' relevance, and links to relevant articles in the meeting invite.

7. The method of claim 1, wherein the data feeds are updated in response to a request by one of the participants, wherein the updating occurs at one or more of when a meeting invitation is sent, on the day of the meeting, and periodically on a regular interval.

8. An apparatus for determining data feeds in an electronic calendar, the apparatus comprising:
a client calendar application configured to present meeting schedules and participant related data feeds;
a user profile database including information about the meeting participants; and
a calendar management server configured to identify participants of a meeting scheduled in the electronic calendar, determine topics relevant to the participants of the meeting, select data feeds based on the topics relevant to the participants of the meeting, wherein the data feeds provide information about the topics, and present the data feeds to one or more of the participants of the meeting.

9. The apparatus of claim 8 wherein the calendar management server is further configured to determine the participants' meeting schedules and display one or more alternate schedules because one or more of the participants has a scheduling conflict.

10. The apparatus of claim 8, wherein the determining topics includes searching for key words in profiles associated with the participants, wherein the profiles are stored in a profile database associated with the electronic calendar.

11. The apparatus of claim 8, wherein the information about the topics includes one or more of personal notes about one or more of the participants, links to online articles, information from social networking websites, electronic business cards, data from a participant's employer database, and information from web pages about one or more of the participants.

12. The apparatus of claim 8, wherein the calendar management server can be configured to arrange and present information for data feeds based on one or more of the data feeds' sources and the data feeds' ages.

13. The apparatus of claim 8, wherein presenting the data feeds can include any one or more of ordering data feeds based on their reliability, color coding data feeds depending on the data feeds' relevance, and links to relevant articles in the meeting invite.

14. The apparatus of claim 8, wherein the data feeds are updated in response to a request by one of the participants, wherein the updating occurs at one or more of when a meeting invitation is sent, on the day of the meeting, and periodically on a regular interval.

15. One or more machine-readable media having stored therein a program product, which when executed a set of one or more processor units causes the set of one or more processor units to perform operations for determining data feeds in an electronic calendar, the operations comprising:
identifying participants of a meeting scheduled in the electronic calendar;
determining topics relevant to the participants of the meeting;
selecting data feeds based on the topics relevant to the participants of the meeting, wherein the data feeds provide information about the topics; and
presenting the data feeds to one or more of the participants of the meeting.

16. The one or more machine-readable media of claim 15, further comprising:
determining the participants' meeting schedules; and
displaying one or more alternate schedules because one or more of the participants has a scheduling conflict.

17. The one or more machine-readable media of claim 15, wherein the determining topics includes searching for key words in profiles associated with the participants, wherein the profiles are stored in a profile database associated with the electronic calendar.

18. The one or more machine-readable media of claim 15, wherein the information about the topics includes one or more of personal notes about one or more of the participants, links to online articles, information from social networking websites, electronic business cards, data from a participant's employer database, and information from web pages about one or more of the participants.

19. The one or more machine-readable media of claim 15, wherein presenting the data feeds can include any one or more of ordering data feeds based on their reliability, color coding data feeds depending on the data feeds' relevance, and links to relevant articles in the meeting invite.

20. The one or more machine-readable media of claim 15, wherein the data feeds are updated in response to a request by one of the participants, wherein the updating occurs at one or more of when a meeting invitation is sent, on the day of the meeting, and periodically on a regular interval.
